(19) United States
(12) Patent Application Publication
(10) Pub. No.: US 2005/0212784 A1
(43) Pub. Date: Sep. 29, 2005

(54) Liquid crystal display system with a storage capability

(75) Inventor: Jen-Chuan Wang, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/055,614

(22) Filed: Feb. 11, 2005

(30) Foreign Application Priority Data
Mar. 24, 2004 (TW) 093107961

(51) Int. Cl. G09G 3/36

(52) U.S. Cl. 345/204

(57) ABSTRACT

A liquid crystal display system with a storage capability includes an image input interface, a buffer, a de-interlacing device, an upscaling/downscaling device, an image processing device, an image processing device, a buffer controller, a storage media interface and a direct memory access controller. The image input interface is used for receiving an image data stream. The buffer is coupled to the image input interface and used for temporarily storing the image data stream. The storage media interface is coupled to external storage media and the buffer and used for sending an image data stream stored in the storage media to the buffer for display, or sending an image data stream stored in the buffer to the storage media for storage. The direct memory access buffer controller is used for increasing a data access speed between the storage media interface and the buffer.

### BACKGROUND OF THE INVENTION

1. Field of the Invention

The present invention relates to a liquid crystal display system and, more particularly, to a liquid crystal display system with a storage capability.

2. Description of the Related Art

It is clear that “smaller size” has become the guiding idea of electronic products today. For example, old televisions use cathode-ray tubes, which lead to the enormous sizes of these televisions. The advent of liquid crystal displays has reduced the sizes of televisions.

Current liquid crystal televisions combine a liquid crystal display and a television signal decoder so that the user can watch TV programs on the liquid crystal display. The user can also connect the liquid crystal display to a computer for use as an output device of the computer. Regardless of whether the liquid crystal display is showing TV programs or being used as an output device for a computer signal, the liquid crystal display can only output a video signal, which is insufficient for some applications.

Therefore, it is desirable to provide a liquid crystal display system with storage functionality to mitigate and/or obviate the aforementioned problems.

### SUMMARY OF THE INVENTION

A main objective of the present invention is to provide a liquid crystal display system with a storage capability that can store a TV program therein.

In order to achieve the above-objective, liquid crystal display system with a storage functionality comprises: an image input interface, a buffer, a de-interlacing device, an upscaling/downscaling device, an image processing device, an image processing device, a buffer controller, a storage media interface and a direct memory access controller. The image input interface is used for receiving an image data stream. The buffer is coupled to the image input interface and used for temporarily storing the image data stream. The de-interlacing device is coupled to the buffer and used for transforming the image data stream from an interlaced format to a non-interlaced format. The upscaling/downscaling device is coupled to the de-interlacing device and used for scaling up or scaling down the image data stream in the non-interlaced format in accordance with the resolution of the liquid crystal display. The image processing device is coupled to the upscaling/downscaling device and used for performing an image process to the upscaled or downscaled image data stream to increase the image quality of the image data stream. The buffer controller is used for controlling access to the buffer. The storage media interface is coupled to external storage media and the buffer and used for sending an image data stream stored in the storage media to the buffer for display, or sending an image data stream stored in the buffer to the storage media for storage. The direct memory access buffer controller is used for increasing a data access speed between the storage media interface and the buffer.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a liquid crystal display system with a storage capability in accordance with the present invention.

FIG. 2 shows a schematic view of image data transmission when the present invention plays a television program.

FIG. 3 shows a schematic view of a non-interlaced transformation in accordance with the present invention.

FIG. 4 shows a schematic view of playing image data stored on a storage media in accordance with the present invention.

FIG. 5 shows a schematic view of storing image data of a TV program in accordance with the present invention.

### DETAILED DESCRIPTION OF THE PREFERRED EMBODIMENT

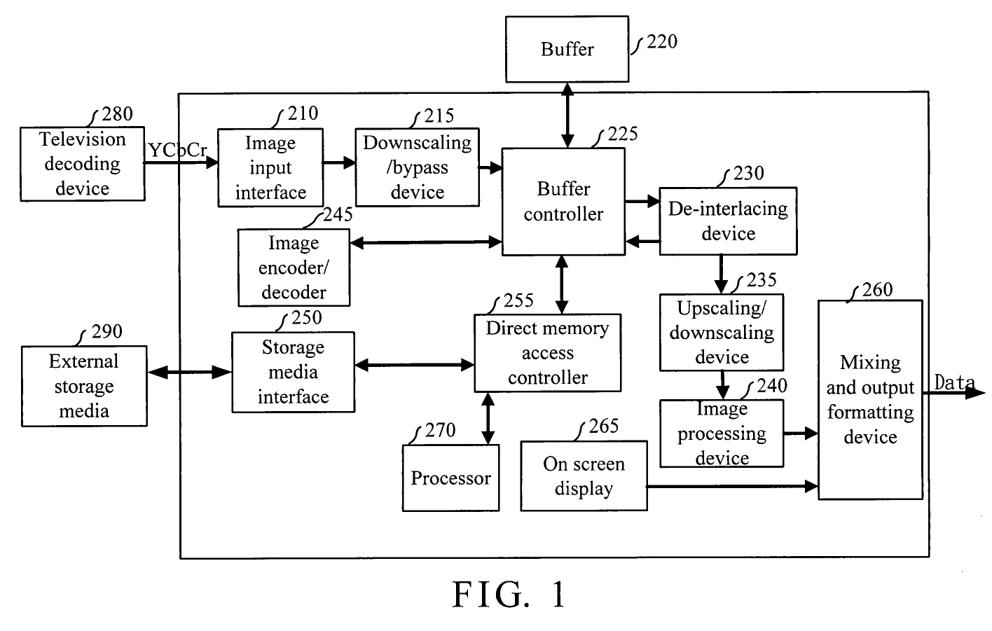

Please refer to FIG. 1. FIG. 1 is a block diagram of a liquid crystal display system with a storage capability in accordance with the present invention. The liquid crystal display system comprises an image input interface 210, a downscaling/bypass device 215, a buffer 220, a buffer controller 225, an de-interlacing device 230, an upscaling/downscaling device 235, an image processing device 240, an image encoder/decoder 245, a storage media interface 250, a direct memory access controller 255, a mixing and output formatting device 260, an on screen display 265 and a processor 270.

The image input interface 210 is coupled to an external television decoding device 280 and is used for receiving a digital image data stream from the television decoding device 280. The format of the digital image data stream can be YCbCr or RGB. The downscaling/bypass device 215 performs a down scaling or direct bypass operation in accordance with the resolution of the liquid crystal display. The buffer 220 is coupled to the downscaling/bypass device 215 and is used for temporarily storing the image data stream. The buffer controller 225 is used for controlling access to the buffer 220.

The de-interlacing device 230 is coupled to the buffer 220 and is used for transforming the image data stream from an interlaced format to a non-interlaced format. The upscaling/downscaling device 235 is coupled to the de-interlacing device 230 and is used for scaling up or down the image data stream in the non-interlaced format in accordance with the resolution of the liquid crystal display. The image processing device 240 is coupled to the upscaling/downscaling device 235 and is used for performing an image process to the upscaled or downscaled image data stream to increase the image quality of the image data stream. The image process performed can be a brightness procedure, a contrast procedure, a hue procedure or a saturation procedure.

The on screen display (OSD) 265 is used for displaying data related to the liquid crystal display, such as brightness, contrast, image locking, the display mode used, etc. The mixing and output formatting device 260 is coupled to the on screen display 265 and the image processing device 240 and is used for overlapping the output image from the on screen display 265 and the output image data stream of the image processing device 240, and then outputting the image to the liquid crystal display for display.

The storage media interface 250 is coupled to an external storage media 290 and is used for sending an image data stream stored in the storage media 290 to the buffer 220 for display, or sending an image data stream stored in the buffer 220 to the storage media 290 for storage. The external storage media 290 can be a CF card, an SD card, a memory stick card, a smart media card, a multi media card or a macro drive, or even a hard disk with an ATA interface. The direct memory access controller 255 is used for increasing the data access speed between the storage media 250 and the buffer 220.

The image encoder/decoder 245 is coupled to the buffer 220 and is used for encoding the image data stream in the buffer 220 and then sending the image data stream to the storage media interface 250 to be stored in the external storage media 290. The image encoder/decoder 245 is also used for decoding the image data stream in the buffer 220 read from the storage media interface 250 for display. The image encoder/decoder 245 is a JPEG encoder/decoder and is used for performing a JPEG encoding/decoding procedure to the image stream. The image encoder/decoder 245 can also be an MPEG2 encoder/decoder and, which is used for performing an MPEG2 encoding/decoding procedure to the image stream. The image encoder/decoder 245 can also be an MPEG4 encoder/decoder used for performing an MPEG4 encoding/decoding procedure to the image stream.

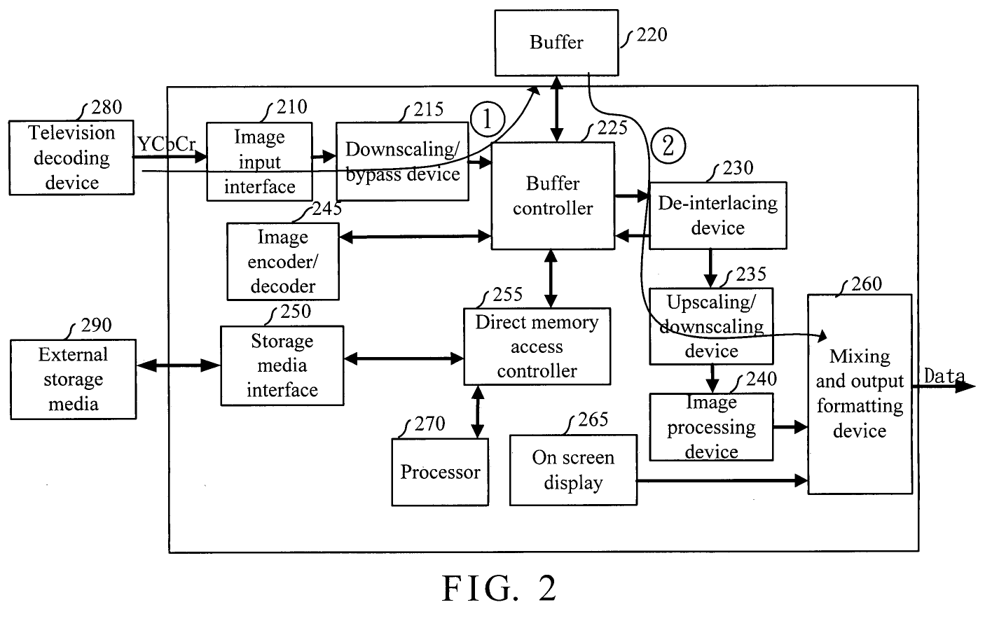

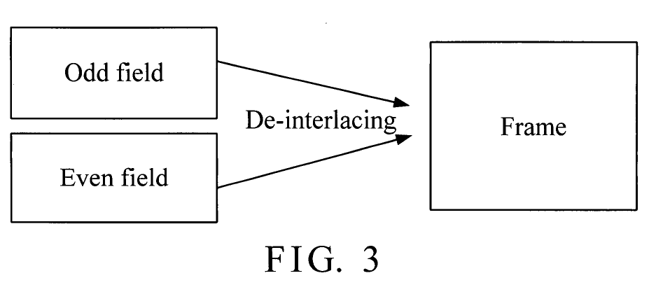

Please refer to FIG. 2. FIG. 2 shows a schematic view of data transmission when the present invention plays a television program. An analog TV program signal is decoded as a digital YCbCr data stream by the television decoding device 280, and the digital YCbCr data stream is output to the image input interface 210. Since the typical resolution of a TV program signal is lower than the resolution of the liquid crystal display, the downscaling/bypass device 215 performs a direct bypass operation to send the digital YCbCr data stream to the buffer 220. The buffer controller 225 reads the digital YCbCr data stream from the buffer 220 and sends the digital YCbCr data stream to the de-interlacing device 230 to transform the digital YCbCr data stream from an interlaced format to a non-interlaced format. As shown in FIG. 3, the odd fields and even fields in the digital YCbCr data stream are transformed into a non-interlaced frame.

The non-interlaced digital YCbCr data stream is scaled up by the upscaling/downscaling device 235 to match the resolution of the liquid crystal display. Then, the image processing device 240 performs brightness, contrast, hue or saturation image processes to improve the image quality of the non-interlaced digital YCbCr data stream. Finally, the mixing and output formatting device 260 mixes OSD data from the on screen display 265 with the non-interlaced digital YCbCr data stream and generates a proper output data stream for the liquid crystal display.

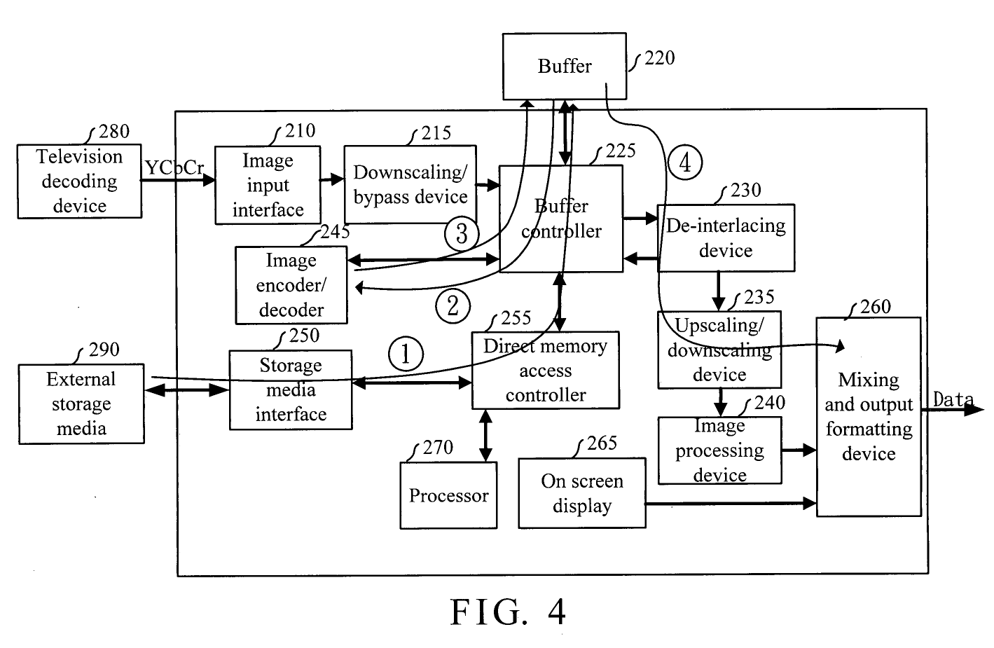

Please refer to FIG. 4. FIG. 4 shows a schematic view of playing image data stored in a storage media in accordance with the present invention. The image data is stored in the external storage media 290 in a compressed format. The processor 270 reads a file header of the image data from the storage media interface 250 and decodes the file header of the image data to obtain information about the image data, such as compression format or size. The processor 270 sets the direct memory access controller 255 to move the image data to the buffer 220. Then, the image encoder/decoder 245 decompresses the image data and sends back the decoded image data to the buffer 220. The buffer controller 225 reads the decompressed image data from the buffer 220 and sends the decompressed image data to the de-interlacing device 230, the upscaling/downscaling device 235 and the image processing device 240 to generate a proper output data stream for the liquid crystal display.

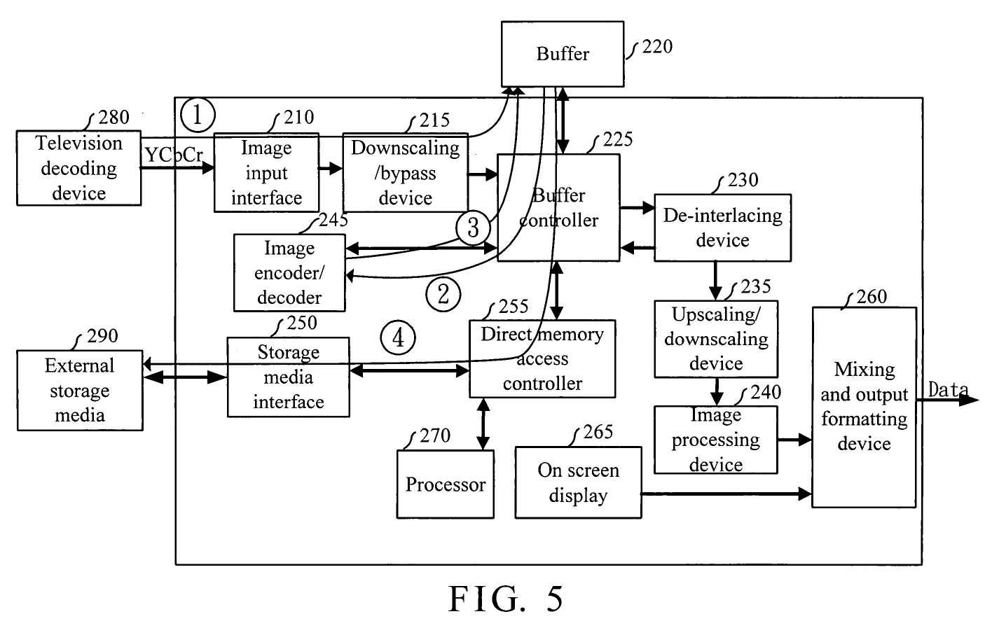

Please refer to FIG. 5. FIG. 5 shows a schematic view of storing image data of a TV program in accordance with the present invention. An analog TV program signal is decoded into a digital YCbCr data stream by the television decoding device 280 and output to the image input interface 210. In order to save space, the downscaling/bypass device 215 performs a downscaling operation to the digital YCbCr data stream and sends the downscaling digital YCbCr data stream to the buffer 220. The image encoder/decoder 245 encodes the YCbCr data stream and sends back the encoded data stream to the buffer 220. The buffer controller 225 reads the encoded data stream from the buffer 220 and sends encoded data stream to the direct memory access controller 255 for being stored in the external storage media 290 through the storage media interface 250. Therefore, the entire TV program is recorded and can be played by the data transmission path shown in FIG. 4.

In accordance with the above description, the present invention utilizes the storage media interface 250 and the direct memory access controller 255 to store a TV program in the external storage media 290 for later display, which offers more convenience to the user.

Although the present invention has been explained in relation to its preferred embodiment, it is to be understood that many other possible modifications and variations can be made without departing from the spirit and scope of the invention as hereinafter claimed.

1. A liquid crystal display system with a storage capability comprising:
an image input interface for receiving an image data stream;
a buffer coupled to the image input interface and used for temporarily storing the image data stream;
a de-interlacing device coupled to the buffer and used for transforming the image data stream from an interlaced format to a non-interlaced format;
an upscaling/downscaling device coupled to the de-interlacing device and used for scaling up or scaling down the image data stream in the non-interlaced format in accordance with the resolution of the liquid crystal display;
an image processing device coupled to the upscaling/downscaling device and used for performing an image process to the upscaled or downscaled image data stream to increase the image quality of the image data stream;
a buffer controller used for controlling access to the buffer;
a storage media interface coupled to external storage media and the buffer and used for sending an image data stream stored in the storage media to the buffer for display, or sending an image data stream stored in the buffer to the storage media for storage; and
a direct memory access buffer controller for increasing a data access speed between the storage media interface and the buffer.

2. The system as claimed in claim 1 further comprising:
an image encoder/decoder coupled to the buffer and used for encoding the image data stream in the buffer and then sending the image data stream to the storage media interface for storage in the external storage media, or decoding the image data stream in the buffer read by the storage media interface.

3. The system as claimed in claim 1 further comprising:
an on screen display (OSD) for displaying data relating to the liquid crystal display; and
a mixing and output formatting device coupled to the on screen display and the image process device and used for overlapping the output image from the on screen display and the output image data stream for display.

4. The system as claimed in claim 2, wherein the image encode/decoder is a JPEG encoder/decoder and used for performing a JPEG encoding/decoding procedure to the image stream.

5. The system as claimed in claim 2, wherein the image encode/decoder is an MPEG2 encode/decoder and used for performing an MPEG2 encoding/decoding procedure to the image stream.

6. The system as claimed in claim 2, wherein the image encode/decoder is a MPEG4 encode/decoder and used for performing MPEG4 encoding/decoding to the image.

7. The system as claimed in claim 1, wherein the image input interface is coupled to an external television decoding device and used for receiving a digital image data stream from television decoding device.

8. The system as claimed in claim 7, wherein the digital image data stream is in YCbCr format or RGB format.
